(19) United States
(12) Patent Application Publication
(10) Pub. No.: US 2024/0409820 A1
(43) Pub. Date: Dec. 12, 2024

(54) PYROLYSIS GAS TREATMENT INCLUDING CAUSTIC SCRUBBER

(71) Applicant: Eastman Chemical Company, Kingsport, TN (US)

(72) Inventors: David Eugene Slivensky, Tatum, TX (US); Daryl Bitting, Longview, TX (US); Michael Gary Polasek, Longview, TX (US); Xianchun Wu, Longview, TX (US)

(73) Assignee: Eastman Chemical Company, Kingsport, TN (US)

(21) Appl. No.: 18/691,643

(22) PCT Filed: Sep. 16, 2022
(86) PCT No.: PCT/US2022/043743

§ 371 Date: Mar. 13, 2024

Related U.S. Application Data
(60) Provisional application No. 63/261,425, filed on Sep. 21, 2021.

(51) Int. Cl. C10G 19/02; B01D 53/14; C10B 53/07; C10G 55/04

(52) U.S. Cl. CPC C10G 19/02; B01D 53/1425; B01D 53/1475; C10B 53/07; C10G 55/04; B01D 2257/504; C10G 2300/1003

(57) ABSTRACT

Processes and facilities for recovering and purifying a pyrolysis gas formed by pyrolyzing waste plastic are provided. The purification process may comprise one or more treatment processes, including a caustic scrubber process, which may be included in a cracker facility or separate from the cracker facility. The resulting gas effluent stream from the caustic scrubber is particularly useful for recovering recycled chemical products and co-products from a downstream cryogenic separation process.

### BACKGROUND

Waste plastic pyrolysis plays a part in a variety of chemical recycling technologies. Typically, waste plastic pyrolysis facilities focus on producing recycled content pyrolysis oil (r-pyoil) that can be used in making recycled content products. Waste plastic pyrolysis also produces heavy components (e.g., waxes, tar, and char) and recycled content pyrolysis gas (r-pygas). Although r-pygas produced by the waste plastic pyrolysis typically has 100 percent recycled content, it is common practice for the r-pygas to be burned as fuel to provide heat for the pyrolysis reaction. While burning r-pygas as fuel may be economically efficient, such practice runs counter to one of the main goals of chemical recycling, which is to transform as much of the waste plastic as possible into new products. However, the raw r-pygas stream generally comprises some quantity of carbon dioxide, hydrogen disulfide, and/or other components that are undesirable for downstream separations and/or other chemical recycling processes.

### SUMMARY

In one aspect, the present technology concerns a process for purifying pyrolysis gas (pygas), the process comprising: (a) providing a pygas comprising one or more of: (i) greater than 1 ppm of hydrochloric acid (HCl); (ii) greater than 1 ppm of carbon dioxide (CO₂); and/or (iii) greater than 1 ppm of hydrogen sulfide (H₂S); and (b) introducing a feedstock stream comprising at least a portion of the pygas into a caustic scrubber process within a cracker facility.

In one aspect, the present technology concerns a process for purifying pyrolysis gas (pygas), the process comprising: (a) treating a pyrolysis gas (pygas) stream to provide a treated pygas stream depleted in halogens, carbon dioxide (CO₂), and/or sulfur; and (b) introducing at least a portion of the treated pygas stream into a caustic scrubber process.

In one aspect, the present technology concerns a process for purifying pyrolysis gas (pygas), the process comprising: (a) combining at least a portion of a cracker furnace effluent stream with a pyrolysis gas (pygas) stream to form a combined stream; and (b) feeding at least a portion of the combined stream into a caustic scrubber process.

In one aspect, the present technology concerns a process for purifying pyrolysis gas (pygas), the process comprising: (a) treating a pyrolysis gas (pygas) stream in an absorber-stripper system to provide a treated pygas stream; and (b) introducing at least a portion of the treated pygas stream into a caustic scrubber process within a cracker facility.

### BRIEF DESCRIPTION OF THE DRAWINGS

FIG. 1 is a block flow diagram illustrating the main steps of a process and facility for treating recycled content pyrolysis gas for use in downstream processing to produce recycled chemical products and coproducts; and

FIG. 2 is a flow diagram illustrating the main steps of a process for treating pyrolysis gas in a caustic scrubber system.

### DETAILED DESCRIPTION

We have discovered new methods and systems for utilizing a recycled content stream that was previously burned as fuel. More specifically, we have discovered that pyrolysis gas produced by pyrolyzing waste plastic can be treated to be used to produce recycled content products. In particular, the pyrolysis gas can be optionally combined with at least a portion of a cracker furnace effluent stream and introduced into a caustic scrubber process, which can effectively remove some amount of carbon dioxide, hydrogen disulfide, and/or other components from the pyrolysis gas or combined effluent stream.

As used herein, the term “recycled content” refers to being or comprising a composition that is directly and/or indirectly derived from recycled material, for example recycled waste plastic. Throughout this description, various recycled content components may be denoted by “r-[component].” However, it should be understood that any component that is directly and/or indirectly derived from recycled material may be considered a recycled content component, regardless whether the denotation is used.

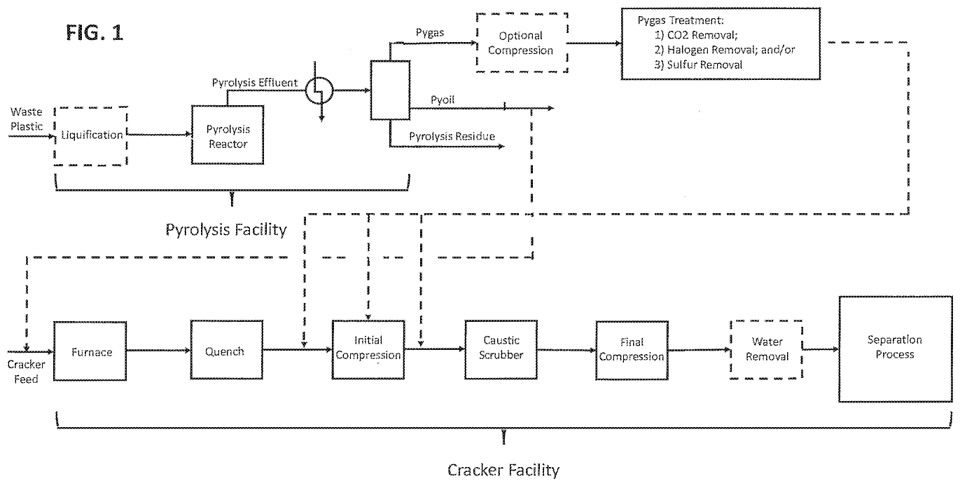

FIG. 1 illustrates one embodiment of a process and system for use in chemical recycling of waste plastic. The process shown in FIG. 1 includes a pyrolysis facility and a cracking facility. The pyrolysis facility and cracking facility may be co-located or located remotely from one another. As used herein, the term “co-located” refers to the characteristic of at least two objects being situated on a common physical site, and/or within 0.5 or 1 mile of each other. As used herein, the term “located remotely” refers to a distance of greater than 1, greater than 5, greater than 10, greater than 50, greater than 100, greater than 500, greater than 1000, or greater than 10,000 miles between two facilities, sites, or reactors.

When two or more facilities are co-located, the facilities may be integrated in one or more ways. Examples of integration include, but are not limited to, heat integration, utility integration, waste-water integration, mass flow integration via conduits, office space, cafeterias, integration of plant management, IT department, maintenance department, and sharing of common equipment and parts, such as seals, gaskets, and the like.

In some embodiments, the pyrolysis facility/process is a commercial scale facility/process receiving the waste plastic feedstock at an average annual feed rate of at least 100, or at least 500, or at least 1,000, at least 2,000, at least 5,000, at least 10,000, at least 50,000, or at least 100,000 pounds per hour, averaged over one year. Further, the pyrolysis facility can produce the r-pyoil and r-pygas in combination at an average annual rate of at least 100, or at least 1,000, or at least 5,000, at least 10,000, at least 50,000, or at least 75,000 pounds per hour, averaged over one year.

Similarly, the cracking facility/process can be a commercial scale facility/process receiving hydrocarbon feed at an average annual feed rate of at least at least 100, or at least 500, or at least 1,000, at least 2,000, at least 5,000, at least 10,000, at least 50,000, or at least 75,000 pounds per hour, averaged over one year. Further, the cracking facility can produce at least one recycled content product stream (r-product) at an average annual rate of at least 100, or at least 1,000, or at least 5,000, at least 10,000, at least 50,000, or at least 75,000 pounds per hour, averaged over one year. When more than one r-product stream is produced, these rates can apply to the combined rate of all r-products and r-coproducts.

As shown in FIG. 1, the process begins by feeding the waste plastic to a pyrolysis facility. In some embodiments, the waste plastic comprises at least 80, at least 90, at least 95, at least 99, or at least 99.9 percent by weight polyolefins. In some embodiments, the waste plastic comprises not more than 10, not more than 5, not more than 1, not more than 0.5, not more than 0.3, not more than 0.2, or not more than 0.1 percent by weight polyesters (e.g., PET). Such low levels of polyesters, such as PET, can be desirable so as to avoid formation of formic acid, acetic acid, others that can cause corrosive compounds to build up in downstream processes. In some embodiments, the waste plastic comprises not more than 0.1 percent by weight polyvinyl chloride (PVC). However, in some embodiments greater content of chloride and/or other halogens may be present in the waste plastic, for example, if one or more halogen removal processes are utilized in downstream processing, as described herein.

In some embodiments, the pyrolysis facility comprises a liquification zone for liquifying at least a portion of the waste plastic feed. The liquification zone may comprise a process for liquifying the waste plastic by one or more of: (i) heating/melting; (ii) dissolving in a solvent; (iii) depolymerizing; (iv) plasticizing, and combinations thereof. Additionally, one or more of options (i) through (iv) may also be accompanied by the addition of a blending agent to help facilitate the liquification (reduction of viscosity) of the polymer material.

In some embodiments, the liquification zone includes at least a melt tank and a heater. The melt tank receives the waste plastic feed and the heater heats waste plastic stream. The melt tank can include one or more continuously stirred tanks. When one or more rheology modification agents (e.g., solvents, depolymerization agents, plasticizers, and blending agents) are used in the liquification zone, such rheology modification agents can be added to and/or mixed with the waste plastic in the melt tank. The heater of the liquification zone can take the form of internal heat exchange coils located in the melt tank and/or an external heat exchanger. The heater may transfer heat to the waste plastic via indirect heat exchange with a process stream or heat transfer medium, such as in the heat integration processes described in greater detail below.

Within the pyrolysis facility, the waste plastic or liquified waste plastic is fed to a pyrolysis step where the waste plastic is pyrolyzed in a pyrolysis reactor. The pyrolysis reaction involves chemical and thermal decomposition of the sorted waste plastic introduced into the reactor. Although all pyrolysis processes may be generally characterized by a reaction environment that is substantially free of oxygen, pyrolysis processes may be further defined, for example, by the pyrolysis reaction temperature within the reactor, the residence time in the pyrolysis reactor, the reactor type, the pressure within the pyrolysis reactor, and the presence or absence of pyrolysis catalysts. The pyrolysis reactor can be, for example, a film reactor, a screw extruder, a tubular reactor, a tank, a stirred tank reactor, a riser reactor, a fixed bed reactor, a fluidized bed reactor, a rotary kiln, a vacuum reactor, a microwave reactor, or an autoclave.

The pyrolysis reaction can involve heating and converting the waste plastic feedstock in an atmosphere that is substantially free of oxygen or in an atmosphere that contains less oxygen relative to ambient air. For example, the atmosphere within the pyrolysis reactor may comprise not more than 5, not more than 4, not more than 3, not more than 2, not more than 1, or not more than 0.5 weight percent of oxygen.

In one embodiment or in combination with one or more embodiments disclosed herein, the pyrolysis reaction performed in the pyrolysis reactor can be carried out at a temperature of less than 700° C., less than 650° C., or less than 600° C. and at least 300° C., at least 350° C., or at least 400° C. The feed to the pyrolysis reactor can comprise, consists essentially of, or consists of waste plastic. The feed stream, and/or the waste plastic component of the feed stream, can have a number average molecular weight (Mn) of at least 3000, at least 4000, at least 5000, or at least 6000 g/mole. If the feed to the pyrolysis reactor contains a mixture of components, the Mn of the pyrolysis feed is the weighted average Mn of all feed components, based on the mass of the individual feed components. The waste plastic in the feed to the pyrolysis reactor can include post-consumer waste plastic, post-industrial waste plastic, or combinations thereof. In certain embodiments, the feed to the pyrolysis reactor comprises less than 5, less than 2, less than 1, less than 0.5, or about 0.0 weight percent coal and/or biomass (e.g., lignocellulosic waste, switchgrass, fats and oils derived from animals, fats and oils derived from plants, etc.), based on the weight of solids in pyrolysis feed or based on the weight of the entire pyrolysis feed. The feed to the pyrolysis reaction can also comprise less than 5, less than 2, less than 1, or less than 0.5, or about 0.0 weight percent of a co-feed stream, including steam, sulfur-containing co-feed streams, and/or non-plastic hydrocarbons (e.g., non-plastic hydrocarbons having less than 50, less than 30, or less than 20 carbon atoms), based on the weight of the entire pyrolysis feed other than water or based on the weight of the entire pyrolysis feed. The reactor may also utilize a feed gas and/or lift gas for facilitating the introduction of the feed into the pyrolysis reactor. The feed gas and/or lift gas can comprise nitrogen and can comprise less than 5, less than 2, less than 1, or less than 0.5, or about 0.0 weight percent of steam and/or sulfur-containing compounds.

The temperature in the pyrolysis reactor can be adjusted to facilitate the production of certain end products. In some embodiments, the peak pyrolysis temperature in the pyrolysis reactor can be at least 325° C., or at least 350° C., or at least 375° C., or at least 400° C. Additionally or alternatively, the peak pyrolysis temperature in the pyrolysis reactor can be not more than 800° C., not more than 700° C., or not more than 650° C., or not more than 600° C., or not more than 550° C., or not more than 525° C., or not more than 500° C., or not more than 475° C., or not more than 450° C., or not more than 425° C., or not more than 400° C. More particularly, the peak pyrolysis temperature in the pyrolysis reactor can range from 325 to 800° C., or 350 to 600° C., or 375 to 500° C., or 390 to 450° C., or 400 to 500° C.

The residence time of the feedstock within the pyrolysis reactor can be at least 1, or at least 5, or at least 10, or at least 20, or at least 30, or at least 60, or at least 180 seconds. Additionally, or alternatively, the residence time of the feedstock within the pyrolysis reactor can be less than 2, or less than 1, or less than 0.5, or less than 0.25, or less than 0.1 hours. More particularly, the residence time of the feedstock within the pyrolysis reactor can range from 1 second to 1 hour, or 10 seconds to 30 minutes, or 30 seconds to 10 minutes.

The pyrolysis reactor can be maintained at a pressure of at least 0.1, or at least 0.2, or at least 0.3 barg and/or not more than 60, or not more than 50, or not more than 40, or not more than 30, or not more than 20, or not more than 10, or not more than 8, or not more than 5, or not more than 2, or not more than 1.5, or not more than 1.1 barg. The pressure within the pyrolysis reactor can be maintained at atmospheric pressure or within the range of 0.1 to 60, or 0.2 to 10, or 0.3 to 1.5 barg.

The pyrolysis reaction in the reactor can be thermal pyrolysis, which is carried out in the absence of a catalyst, or catalytic pyrolysis, which is carried out in the presence of a catalyst. When a catalyst is used, the catalyst can be homogenous or heterogeneous and may include, for example, certain types of zeolites and other mesostructured catalysts.

As shown in FIG. 1, a pyrolysis effluent is produced and removed from the reactor and generally comprises pyrolysis oil (pyoil), pyrolysis gas (pygas), and pyrolysis residue. As used herein, the terms “pyrolysis gas” or “pygas” refers to a composition obtained from waste plastic pyrolysis that is gaseous at 25° C. at 1 atm. As used herein, the terms “pyrolysis oil” or “pyoil” refers to a composition obtained from waste plastic pyrolysis that is liquid at 25° C. and 1 atm. As used herein, the term “pyrolysis residue” refers to a composition obtained from waste plastic pyrolysis that is not pygas or pyoil and that comprises predominantly pyrolysis char and pyrolysis heavy waxes. As used herein, the term “pyrolysis char” refers to a carbon-containing composition obtained from pyrolysis that is solid at 200° C. and 1 atm. As used herein, the term “pyrolysis heavy waxes” refers to C20+ hydrocarbons obtained from pyrolysis that are not pyrolysis char, pyrolysis gas, or pyrolysis oil.

In some embodiments, the pyrolysis effluent may comprise in the range of 20 to 99 weight percent, 25 to 80 weight percent, 30 to 85, 30 to 80, 30 to 75, 30 to 70, or 30 to 65 weight percent of the pyrolysis oil. In some embodiments, the pyrolysis effluent may comprise 1 to 90, 10 to 85, 15 to 85, 20 to 80, 25 to 80, 30 to 75, or 35 to 75 weight percent of the pyrolysis gas. In some embodiments, the pyrolysis effluent may comprise in the range of 0.1 to 25, 1 to 15, 1 to 8, or 1 to 5 weight percent of the pyrolysis residue.

In some embodiments, the pyrolysis effluent may comprise not more than 15, not more than 10, not more than 5, not more than 2, not more than 1, or not more than 0.5 weight percent of free water. As used herein, the term “free water” refers to water previously added to the pyrolysis unit and water generated in the pyrolysis unit.

The pyrolysis effluent generally leaves the pyrolysis reactor at very high temperatures (e.g., 500° C. to 800° C.) and thus must be cooled and at least partially condensed before being separated into respective pyrolysis gas, pyrolysis oil, and pyrolysis residue streams. The heat from the pyrolysis effluent can therefore be recovered and used in various processes throughout the chemical recycling process.

In some embodiments, the pyrolysis effluent stream is cooled to a temperature of not more than 60° C., or not more than 50° C. before being fed to the separator. In some embodiments, the pyrolysis effluent stream is cooled to a temperature of 15° C. to 60° C., 25° C. to 45° C., or 30° C. to 40° C. before being fed to the separator.

After cooling, the pyrolysis effluent stream may be fed to a separator to thereby produce a pyrolysis gas (pygas) stream, a pyrolysis (pyoil) stream, and a pyrolysis residue stream. In some embodiments, the pygas stream comprises 1 to 50 weight percent methane and/or 5 to 99 weight percent C2, C3, and/or C4 hydrocarbon content (including all hydrocarbons having 2, 3, or 4 carbon atoms per molecule). The pygas stream may comprise C2 and/or C3 components each in an amount of 5 to 60, 10 to 50, or 15 to 45 weight percent, C4 components in an amount of 1 to 60, 5 to 50, or 10 to 45 weight percent, and C5 components in an amount of 1 to 25, 3 to 20, or 5 to 15 weight percent. The pyrolysis gas may have a temperature of 15° C. to 60° C., 25° C. to 45° C., or 30° C. to 40° C. before treatment (described below).

In some embodiments, the pyoil stream comprises at least 50, at least 75, at least 90, or at least 95 weight percent of C4 to C30, C5 to C25, C5 to C22, or C5 to C20 hydrocarbon components. The pyoil can have a 90% boiling point in the range of from 150 to 350° C., 200 to 295° C., 225 to 290° C., or 230 to 275° C. As used herein, “boiling point” refers to the boiling point of a composition as determined by ASTM D2887-13. Additionally, as used herein, an “90% boiling point,” refers to a boiling point at which 90 percent by weight of the composition boils per ASTM D-2887-13.

In some embodiments, the pyoil can comprise heteroatom-containing compounds in an amount of less than 20, less than 10, less than 5, less than 2, less than 1, or less than 0.5 weight percent. As used herein, the term “heteroatom-containing” compound includes any compound or polymer containing nitrogen, sulfur, or phosphorus. Any other atom is not regarded as a “heteroatom” for purposes of determining the quantity of heteroatoms, heterocompounds, or heteropolymers present in the pyoil. Heteroatom-containing compounds include oxygenated compounds. Often, such compounds exist in r-pyoil when the pyrolyzed waste plastic includes polyethylene terephthalate (PET) and/or polyvinyl chloride (PVC). Thus, little to no PET and/or PVC in the waste plastic results in little to no heteroatom-containing compounds in the pyoil.

As shown in FIG. 1, the pygas stream from the pyrolysis effluent separator may be fed to an optional compression zone prior to being introduced to one or more pygas treatment processes. This optional compression zone may include one or more compressors, followed by one or more coolers, and/or a liquid knockout section. In some embodiments, the one or more pygas treatment processes comprise a carbon dioxide removal process, a halogen removal process, and/or a sulfur removal process.

In some embodiments, the carbon dioxide removal process comprises an absorber-stripper system, which can comprise one or more absorber towers and one or more regeneration towers. The process generally comprises introducing the pygas stream into the one or more absorber towers, where the pygas contacts an absorber solvent (i.e., a lean absorber solvent) that is concurrently introduced into the one or more absorber towers. Upon contact, at least a portion of the carbon dioxide and/or other impurities in the pygas stream is absorbed and removed in the rich absorber solvent stream. In some embodiments, the absorber solvent comprises a component selected from the group consisting of amines, methanol, sodium hydroxide, sodium carbonate/bicarbonate, potassium hydroxide, potassium carbonate/bicarbonate, SELEXOL®, glycol ether, and combinations thereof. In some embodiments, the absorber solvent can comprise an absorbing component selected from the group consisting of amines, methanol, SELEXOL®, glycol ether, and combinations thereof. The absorbing component may comprise an amine selected from the group consisting of diethanolamine (DEA), monoethanolamine (MEA), methyldiethanolamine (MDEA), diisopropanolamine (DIPA), diglycolamine (DGA), piperazine, modifications, derivatives, and combinations thereof.

The resulting treated pygas exits the absorber tower(s) overhead and is generally depleted in carbon dioxide relative to the pygas stream fed into the absorber tower(s). In some embodiments, the treated pygas stream comprises not more than 1000 ppm, not more than 500 ppm, not more than 400 ppm, not more than 300 ppm, not more than 200 ppm, or not more than 100 ppm carbon dioxide. In some embodiments, the treated pygas stream is also depleted in sulfur and/or sulfur-containing compounds (e.g., H₂S) relative to the pygas stream fed into the absorber tower(s).

In some embodiments, the treated pygas stream has a temperature of not more than 60° C. after treating in the absorber system. The treated pygas stream may have a temperature of 45° C. to 60° C., or 50° C. to 55° C. after treating in the absorber system. The treated pygas stream may have a temperature of 1° to 40°, 5° to 30°, or 10° to 20° greater than the pygas stream before being fed into the absorber tower(s).

The absorbed carbon dioxide can be removed from the absorber solvent in the regeneration tower(s). Within the regeneration tower(s), the carbon dioxide can be stripped from the rich solvent by contacting the solvent with water/steam. The overhead stream comprising steam and carbon dioxide is then cooled and at least partially condensed to remove the carbon dioxide gas, and the water component is recycled back into the regeneration tower(s).

The one or more regeneration towers generally comprise at least one reboiler, which operates at a temperature high enough to release the carbon dioxide from the absorber solvent but below the degradation temperature of the absorber solvent. In some embodiments, the reboiler operates at a temperature of 105° C. to 130° C., 110° C. to 125° C., or 115° C. to 120° C.

The absorber-stripper system may further comprise one or more additional components or processes as understood in the art for appropriate operation of the system. For example, in some embodiments, a cross-heat exchanger may be utilized to provide appropriate heating and cooling to the absorber solvent. In some embodiments, one or more purge outlets may be included to remove excess solvent, water, or other components from the system. However, such components may also be purged using a reclaimer or temporarily shutting down the system.

In some embodiments, the pygas stream may be treated in a halogen removal process. The pygas stream (carbon dioxide-depleted or untreated) may comprise some quantity of halogens (including halogen-containing compounds), such as chlorines (e.g., chlorides), bromines, and fluorines. In some embodiments, the pygas stream comprises a quantity of organic halogens (e.g., organic chlorides) and/or inorganic halogens (e.g., inorganic chlorides). Organic halogens include compounds with a halogen attached to a carbon. An exemplary organic halogen includes methyl chloride (CH₃Cl). Exemplary inorganic halogens include hydrogen chloride (HCl), hydrogen fluoride (HF), and hydrogen bromide (HBr). Although the pygas stream may include other organic and/or inorganic chlorides, at least a portion of any heavier chlorides will be contained in the pyoil stream, and thus the pygas stream may comprise little or no heavier chloride-containing compounds. Additionally, when an upstream absorber-stripper system is used, the carbon dioxide removal process may also remove at least a portion of the inorganic chlorides (e.g., HCl). Thus, in some embodiments, the CO₂-depleted pygas stream fed to the halogen removal process is also depleted in inorganic halogens (e.g., HCl).

In some embodiments, the pygas stream (CO₂-depleted or untreated) has an inorganic halogen (e.g., inorganic chloride) content of at least 1 ppm, at least 2 ppm, at least 5 ppm, at least 50 ppm, at least 100 ppm, at least 200 ppm, at least 500 ppm, or at least 1000 ppm. In some embodiments, the pygas stream (CO₂-depleted or untreated) comprises 0.1 to 1 weight percent inorganic chlorides (e.g., HCl).

The halogen removal process may comprise one or more absorption, adsorption, and/or reaction steps, which may take place in one or more absorption, adsorption, and/or reaction units. In some embodiments, the halogen removal process may comprise feeding at least a portion of the pygas stream in vapor phase across a halogen-removal material to remove at least a portion of the halogen content and thereby provide a halogen-depleted (treated) pygas stream. The halogen-removal material may be contained in one or more guard bed units. The halogen-removal material may comprise any of a number of materials for removing halogens, and particularly chlorides, such as molecular sieve, metal-oxides (e.g., aluminum oxide (Al₂O₃), calcium oxide, silica, zinc oxide (ZnO), titanium dioxide (TiO₂), zirconium dioxide (ZrO₂), and/or iron oxide (FeO)), carbonates (e.g., sodium carbonate, calcium carbonate), and combinations thereof. Multiple materials may be used in combination, for example, in two or more layers of the materials listed above and/or other materials. In some embodiments, the metal oxides have a surface area at least 1, at least 5, at least 10, at least 50, or at least 100 m²/g.

In some embodiments, a single guard bed may be used. In particular, when the halogen concentration in the pygas stream is relatively low, the run time of the guard bed unit is significantly greater than the regeneration time, and therefore downtime for regeneration of the single guard bed unit is insignificant. However, when greater halogen concentrations are present in the pygas stream, two or more guard bed units may be used. In such embodiments, for example, when the halogen removal material in one guard bed requires replacement or regeneration, operation of that guard bed unit may be ceased, and the pygas stream may be diverted to one or more other guard bed units. Once the halogen removal material is replaced or regenerated, the guard bed unit may continue operation and the pygas stream may then again flow through the guard bed unit.

The halogen removal treatment process generally produces a treated pygas stream, which is depleted in halogens. In some embodiments, the treated pygas stream may be depleted in both organic chlorides and/or inorganic chlorides after the halogen removal treatment process. In some embodiments, the halogen-depleted pygas stream comprises not more than 100 ppm, not more than 50 ppm, not more than 10 ppm, not more than 1 ppm, not more than 0.1 ppm, or not more than 0.01 ppm of chlorides and/or other halogens.

In some embodiments, the pygas stream may be treated in a sulfur removal process to remove sulfur and/or sulfur-containing compounds from the pygas stream. The pygas stream (carbon dioxide-depleted and/or halogen-depleted, or untreated) may comprise some quantity of sulfur and/or sulfur-containing compounds, such as hydrogen sulfide (H₂S), arsine, phosphine, and/or carbonyl sulfide (COS). The amount of such sulfur-containing species will depend on the particular plastic content of the plastic waste material. However, in some embodiments, the pygas stream (carbon dioxide-depleted and/or halogen-depleted, or untreated) comprises at least 25 ppb, at least 100 ppb, at least 500 ppb, or at least 1 ppm of hydrogen sulfide (H₂S), arsine (AsH₃), phosphine (PH₃), and/or carbonyl sulfide (COS). The pygas stream (carbon dioxide-depleted and/or halogen-depleted, or untreated) may comprise 25 ppb to 1000 ppm of hydrogen sulfide (H₂S), arsine (AsH₃), phosphine (PH₃), and/or carbonyl sulfide (COS). In some embodiments, the pygas stream (carbon dioxide-depleted and/or halogen-depleted, or untreated) comprises: (i) at least 1 ppm of hydrogen sulfide (H₂S); (ii) at least 25 ppb of arsine (AsH₃); (iii) at least 25 ppb of phosphine (PH₃); and/or (iv) at least 1 ppm carbonyl sulfide (COS).

The particular treatment pathway may depend on the particular amounts of sulfur-containing species present in the pygas stream. However, the sulfur removal treatment process generally utilizes reactant material(s) and optional catalyst material for converting the fluid phase sulfur-containing species to sulfur-containing metal species. The reactant material(s) and/or catalyst material(s) may be contained in one or more fixed bed units through which the pygas stream may be passed.

As shown in FIG. 8, when the pygas stream comprises a significant quantity of carbonyl sulfide (COS), the COS may first be converted into hydrogen sulfide (H₂S) in order to reduce excessive carbon dioxide (CO₂) from being produced in the sulfur removal reactions as explained below. This optional step comprises contacting the pygas stream with a first reactant material in the presence of a catalyst material. In some embodiments, the first reactant material comprises water (e.g., in the form of steam) and/or hydrogen (H₂). In some embodiments, the catalyst material comprises nickel-molybdenum (NiMo) and/or palladium (Pd). The pygas stream from this first step thus comprises H₂S, at least a portion of which is converted from COS in the pygas stream entering the reactor.

The pygas stream (either from the optional first reactor or without the first reactor) may then be introduced into a second reactor. Within the second reactor, this step comprises contacting the pygas stream with a second reactant material. In some embodiments, the second reactant material may comprise one or more metal-oxide compounds. The second reactant material may comprise the second reactant material comprises zinc-oxide (ZnO), iron (II)-oxide FeO), and/or copper (II)-oxide (CuO).

Contacting the pygas stream with the second reactant material may generally perform one or more of the following reactions: (i) convert at least a portion of the hydrogen sulfide (H₂S) into water and a metal-sulfide; (ii) convert at least a portion of the arsine into water and a metal-arsenide; (iii) convert at least a portion of the phosphine into water and a metal-phosphide; and/or (iv) convert at least a portion of the COS into carbon dioxide (CO₂) and a metal-sulfide. In some embodiments, the metal-sulfide comprises zinc-sulfide (ZnS), iron (II)-sulfide (FeS), and/or copper (II)-sulfide (CuS). In some embodiments, the metal-arsenide comprises zinc-arsenide (Zn₃AS₂), iron (II)-arsenide (FesAs₂), and/or copper (II)-arsenide (CusAS₂). In some embodiments, the metal-phosphide comprises zinc-phosphide (Zn₃P₂), iron (II)-phosphide (FesP₂), and/or copper (II)-phosphide (Cu₃P₂).

In some embodiments, the reactions may be characterized as follows:

| | |
|---|---|
| ZnO + H₂S → H₂O + ZnS | FeO + H₂S → H₂O + FeS |
| ZnO + AsH₃ → H₂O + Zn₃As₂ | FeO + AsH₃ → H₂O + Fe₃As₂ |
| ZnO + PH₃ → H₂O + Zn₃P₂ | FeO + PH₃ → H₂O + Fe₃P₂ |

In some embodiments, the reactions may be characterized as follows:

$$CuO + {H}_{2} S →︀ {H}_{2} O + CuS$$

$$CuO + {AsH}_{3} →︀ {H}_{2} O + {Cu}_{3} {As}_{2}$$

$$CuO + {PH}_{3} →︀ {H}_{2} O + {Cu}_{3} {P}_{2}$$

$$CuO + COS →︀ CuS + {CO}_{2}$$

As noted above, carbonyl sulfide (COS) may be converted to CuS without the optional first reaction to first convert COS to H₂S. However, since carbon dioxide (CO₂) is produced, subsequent CO₂ removal process(es) may be necessary to remove excess CO₂ from the pygas stream. Such downstream CO₂ removal process(es) may include molecular sieves, caustic scrubber systems, and/or other CO₂ removal systems and processes, such as those described above.

Once the sulfur-containing species in the pygas stream are converted to metal sulfur-containing species, these metal species are removed from the pygas stream (e.g., the solid metal materials may remain in the fixed bed as the pygas fluid flows through and exits the reactor) to thereby form a treated sulfur-depleted pygas stream. In some embodiments, the treated sulfur-depleted pygas stream comprises not more than 1,000 ppm, not more than 500 ppm, not more than 200 ppm, or not more than 100 ppm of hydrogen sulfide (H₂S). In some embodiments, the treated sulfur-depleted pygas stream comprises not more than 1,000 ppm, not more than 500 ppm, not more than 200 ppm, or not more than 100 ppm of carbon dioxide (CO₂).

Additionally, the metal-oxide reactant materials in the sulfur removal treatment may also act as a halogen-removal material. Thus, in some embodiments, a quantity of halogens may also be adsorbed and removed from the pygas stream in the sulfur-removal treatment. Therefore, in some embodiments, the halogen removal step and sulfur removal step may occur in the same unit. However, in some embodiments, the halogen removal step and sulfur removal step may occur in separate units, as depicted in the embodiments of the drawings. The particular arrangement may depend on the halogen and sulfur concentrations of the pygas stream and whether separate units should be utilized to achieve the desired pygas purification. The metal-oxide reactant materials may also remove other impurities, such as mercury, lead, and the like.

Regardless of whether the pygas stream is treated using any one or more of the treatment processes or systems described above, at least a portion of the pygas stream may be introduced into a caustic scrubber process, which may be located downstream of the treatment processes (described above) and/or in a cracker facility. The feedstock gas to the caustic scrubber may comprise the pygas stream, or the pygas stream may be combined with at least a portion of an effluent stream from a cracker furnace (described below), which may be in the form of a cracked gas stream, and the combined gas stream can be fed to the caustic scrubber.

The composition of the gas steam fed to the caustic scrubber will depend on factors such as the waste plastic composition, upstream treatment of the pygas stream and pygas stream composition, and whether the pygas is combined with a cracked gas. In some embodiments, the pygas stream (treated or untreated, combined or uncombined) introduced to the caustic scrubber comprises from 1 to 1000 ppm, 5 to 500 ppm, 10 to 300 ppm, or 50 to 200 ppm halogens; from 1 to 1000 pppw, 5 to 500 ppm, 10 to 200 ppm, 50 to 100 ppm hydrochloric acid (HCl); from 1 to 1000 ppm, 5 to 500 ppm, 10 to 200 ppm, or 50 to 100 ppm carbon dioxide (CO₂); and/or from 1 to 1000, 5 to 500, 10 to 200, or 50 to 100 ppm hydrogen sulfide (H₂S). The pygas stream (treated or untreated, combined or uncombined) may be introduced to the caustic scrubber process at a pressure of 100 psia to 300 psia.

In some embodiments, when the pygas stream is first treated in an absorber-stripper system (described above), the treating removes sufficient CO₂ from the pygas stream such that, when combined with at least a portion of the cracker furnace effluent stream, such as a cracked gas stream, the combined stream does not contain an average CO₂ content (as measured over a month period) greater than the operational CO₂ capacity of the caustic scrubber process. For example, treating the pygas stream in the absorber-stripper system may remove sufficient CO₂ such that the combined gas stream fed to the caustic scrubber comprises not more than 1000 ppm, not more than 500 ppm, not more than 400 ppm, not more than 300 ppm, not more than 200 ppm, or not more than 100 ppm CO₂. In some embodiments, treating the pygas stream in the absorber-stripper system removes at least 70, at least 80, at least 90, at least 95, or at least 99 percent of the CO₂ from the pygas stream. Additionally, or alternatively, treating the pygas stream in the absorber-stripper system removes at least 90, at least 95, at least 99, or at least 99.9 percent of the CO₂ and sulfur (including sulfur-containing compounds) from the pygas stream. In some embodiments, the combined gas stream may comprise not more than 100 ppm CO₂ prior to being fed to the caustic scrubber process.

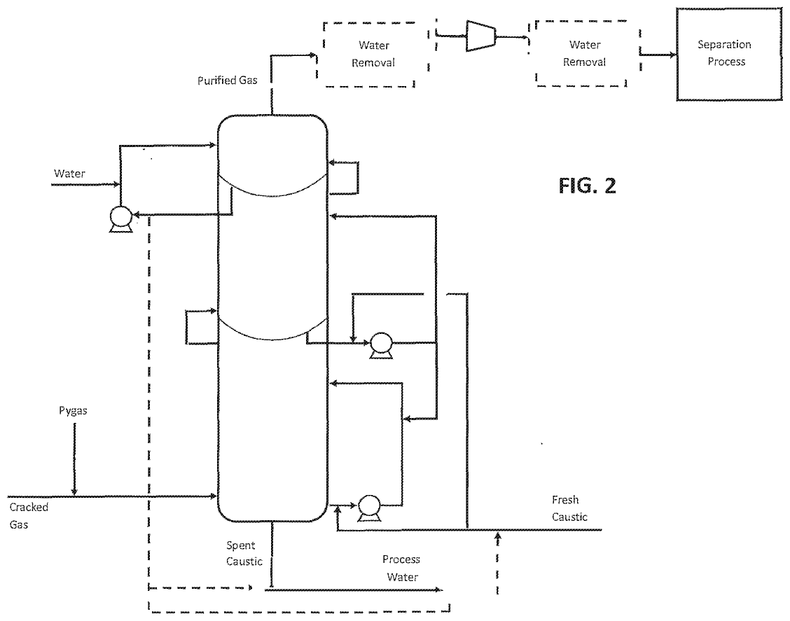

The caustic scrubber system may have a variety of designs and geometries, depending on factors such as gas flow rate and composition. An exemplary caustic scrubber process is shown in FIG. 2. The caustic scrubber shown is a three stage scrubber, although the caustic scrubber can comprise two, three, four, five, or more stages. One or more of the stages may comprise packing material to increase the contact between the gas and liquid phases. In some embodiments, at least one stage is a water wash. In some embodiments, the last (top) stage is a water wash. In some embodiments, the caustic scrubber process operates at a temperature of 25° C. to 65° C.

The gas stream is fed to the bottom stage of the caustic scrubber tower above any liquid accumulated at the scrubber bottoms. Fresh caustic solution can be fed directly to any caustic stage. As the gas flows upward within and between stages, the gas contacts the caustic solution flowing downward, thereby transferring certain gaseous components (e.g., carbon dioxide) to the liquid caustic solution. In some embodiments, the caustic solution comprises a dissolved caustic component selected from the group consisting of sodium hydroxide, potassium hydroxide, calcium oxide, potassium carbonate, and combinations thereof. As noted above, the top stage can be an optional water section, which can remove residual caustic or salts in the gas stream. Additionally, the top water feed can be diverted and used to dilute the fresh caustic feed as needed.

The caustic scrubber process generally removes carbon dioxide (CO₂), sulfur (including sulfur-containing compounds, such as H₂S), and/or other undesirable components from the pygas (or combined) stream, and thereby produces a purified gas stream and a spent caustic solution bottoms stream. In some embodiments, the purified gas stream is CO₂-depleted and/or sulfur-depleted relative to the pygas stream and/or combined feedstock stream to the caustic scrubber process. In some embodiments, the caustic scrubber process produces a purified gas stream comprising not more than 1 ppm CO₂. The spent caustic stream may comprise one or more components that have been removed from the gas stream, such as dissolved carbon dioxide (CO₂) and/or hydrogen sulfide (H₂S). The spent caustic stream (or at least a portion thereof) may then be introduced to a wastewater treatment facility and/or used in a hydrochloric acid (HCl) neutralization process (e.g., to neutralize HCl in gas produced from a plastic liquification process).

As noted above, in some embodiments, the caustic scrubber process may be located within a cracker facility. As shown in FIG. 1, at least a portion of the pygas (which can be optionally treated by any one or more of the treatment processes described above) can be introduced into a cracker facility. In some embodiments, at least 50, at least 75, at least 90, or at least 95 percent of the pygas from the pyrolysis facility can be introduced into the cracker facility. Additionally, or alternatively, all or a portion of the pygas may be introduced into at least one location downstream of the cracker furnace.

When introduced into a location downstream of the cracker furnace, the pygas may be introduced into one or more of the following locations: (i) upstream of the initial compression zone, which compresses the vapor portion of the furnace effluent in two or more compression stages; (ii) within the initial compression zone; and/or (iii) downstream of the initial compression zone but upstream of a caustic scrubber process. In some cases, the pygas stream may be introduced into only one of these locations, while, in other cases, the pygas stream may be divided into additional fractions and each fraction introduced into a different location. In such cases, the fractions of the pygas may be introduced into at least two, or all, of the locations shown in FIG. 1.

The location where the pygas stream may be introduced into the cracker facility may depend on the pressure of the pygas stream, which will depend on whether a compression zone is used upstream of any pygas treatment and the conditions of the pygas treatment process(es). For example, if there is no compression zone upstream of the pygas treatment, then the treated pygas stream may need to be introduced upstream of the initial compression section of the cracker facility. However, if there is a compression zone upstream of the pygas treatment, then the treated pygas stream may be introduced into a location downstream of the initial compression section of the cracker facility.

When introduced into the initial compression section, the pygas may be introduced upstream of the first compression stage, upstream or downstream of the last compression stage, or upstream of one or more intermediate compression stages.

The cracker facility process generally comprises feeding a hydrocarbon feed into the inlet of a cracker furnace. The hydrocarbon feed may comprise predominantly C3 to C5 hydrocarbon components, C5 to C22 hydrocarbon components, or C3 to C22 hydrocarbon components, or even predominantly C2 components. The hydrocarbon feed may include recycled content from one or more sources, or it may include non-recycled content. Additionally, in some cases, the hydrocarbon feed may not include any recycled content. In some embodiments, the hydrocarbon feed can comprise at least a portion of the pyoil stream produced from the pyrolysis facility (described above).

In one embodiment or in combination with one or more embodiments disclosed herein, the cracker furnace can be operated at a product outlet temperature (e.g., coil outlet temperature) of at least 700° C., at least 750° C., at least 800° C., or at least 850° C. The feed to the cracker furnace can have a number average molecular weight (Mn) of less than 3000, less than 2000, less than 1000, or less than 500 g/mole. If the feed to the cracker furnace contains a mixture of components, the Mn of the cracker feed is the weighted average Mn of all feed components, based on the mass of the individual feed components. The feed to the cracker furnace can comprise less than 5, less than 2, less than 1, less than 0.5, or 0.0 weight percent of coal, biomass, and/or solids. In certain embodiments, a co-feed stream, such as steam or a sulfur-containing stream (for metal passivation) can be introduced into the cracker furnace. The cracker furnace can include both convection and radiant sections and can have a tubular reaction zone (e.g., coils in one or both of the convection and radiant sections). Typically, the residence time of the streams passing through the reaction zone (from the convection section inlet to the radiant section outlet) can be less than 20 seconds, less than 10 seconds, less than 5 seconds, or less than 2 seconds.

The hydrocarbon feed can be thermally cracked within the furnace to form a lighter hydrocarbon effluent. The effluent stream can then be cooled in the quench zone and compressed in the compression zone. The compressed stream from the compression zone can then be fed as a cracked gas stream to a caustic scrubber process and then be further separated in the separation zone to produce at least one recycled content chemical product (r-product) and/or coproduct(s). Examples of recycled content products and coproducts include, but are not limited to, recycled content ethane (r-ethane), recycled content ethylene (r-ethylene), recycled content propane (r-propane), recycled content propylene (r-propylene), recycled content butane (r-butane), recycled content butenes (r-butenes), recycled content butadiene (r-butadiene), and recycled content pentanes and heavier (r-C5+). In some embodiments, at least a portion of the recycled content stream (e.g., r-ethane or r-propane) may be returned to the inlet of the cracker furnace as a reaction recycle stream.

When the one or more treated pygas streams are introduced into the cracking facility, the treated pygas may be combined with at least a portion of the cracker effluent (as described above), for example a cracked gas stream, and the combined gas stream may be fed to a caustic scrubber process and/or otherwise processed in the same or similar manner as the cracked gas described above. For example, after treatment in the caustic scrubber, the gas stream can be optionally dehydrated and/or compressed, and introduced into a cryogenic separation process to produce various recycled content chemical products and coproducts, which may be the same or different from those described above. In some embodiments, the recycled content chemical product(s) and co-product(s) comprise olefins (e.g., C2-C5 alkenes), alkanes (e.g., C2-C5 alkanes), aromatics (e.g., benzene, toluene, xylenes, styrene), hydrogen (H2), paraffins, gasoline, and/or C5+ hydrocarbons. In some embodiments, the recycled content product(s) and co-product(s) comprise r-ethylene, r-propylene, r-butylene, r-benzene, r-toluene, r-xylenes, and/or r-styrene.

### Definitions

It should be understood that the following is not intended to be an exclusive list of defined terms. Other definitions may be provided in the foregoing description, such as, for example, when accompanying the use of a defined term in context.

Unless otherwise expressly stated, all “ppm” and “ppb” values expressed are by weight with respect to liquids and solids, and by volume with respect to gases. For multi-phase streams, “ppm” and “ppb” values expressed for components primarily in the gaseous phase are by volume, and “ppm” and “ppb” values expressed for components primarily in the liquid and/or solids phases are by weight.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “co-located” refers to the characteristic of at least two objects being situated on a common physical site, and/or within one mile of each other.

As used herein, the term “commercial scale facility” refers to a facility having an average annual feed rate of at least 500 pounds per hour, averaged over one year.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the term “depleted” refers to having a concentration of a specific component that is less than the concentration of that component in a reference material or stream.

As used herein, the term “enriched” refers to having a concentration of a specific component that is greater than the concentration of that component in a reference material or stream.

As used herein, the term “free water” refers to water previously added (as liquid or steam) to the pyrolysis unit and water generated in the pyrolysis unit.

As used herein, the term “halogen” or “halogens” refers to organic or inorganic compounds, ionic, or elemental species comprising at least one halogen atom.

As used herein, the terms “including,” “include,” and “included” have the same open-ended meaning as “comprising,” “comprises,” and “comprise” provided above.

As used herein, the term “located remotely” refers to a distance of greater than 1, 5, 10, 50, 100, 500, 1000, or 10,000 miles between two facilities, sites, or reactors. As used herein, the term “predominantly” means more than 50 percent by weight. For example, a predominantly propane stream, composition, feedstock, or product is a stream, composition, feedstock, or product that contains more than 50 weight percent propane.

As used herein, the term “pyrolysis” refers to thermal decomposition of one or more organic materials at elevated temperatures in an inert (i.e., substantially oxygen free) atmosphere.

As used herein, the terms “pyrolysis gas” and “pygas” refer to a composition obtained from pyrolysis that is gaseous at 25° C.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the term “recycled content” refers to being or comprising a composition that is directly and/or indirectly derived from recycled material.

As used herein, the term “refined oil” refers to a natural (i.e., non-synthetic) oil that has been subjected to a distillation and/or or purification step.

As used herein, the term “spent caustic stream” refers to a stream that comprises a caustic component and has been discharged from a caustic treatment unit, such as a caustic scrubber unit.

As used herein, the term “waste material” refers to used, scrap, and/or discarded material.

As used herein, the terms “waste plastic” and “plastic waste” refer to used, scrap, and/or discarded plastic materials.

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

### Additional Claim Supporting Description—First Embodiment

In a first embodiment of the present technology, there is provided a process for purifying pyrolysis gas (pygas), the process comprising: (a) providing a pygas comprising one or more of: (i) greater than 1 ppm of hydrochloric acid (HCl); (ii) greater than 1 ppm of carbon dioxide (CO₂); and/or (iii) greater than 1 ppm of hydrogen sulfide (H₂S); and (b) introducing a feedstock stream comprising at least a portion of the pygas into a caustic scrubber process within a cracker facility.

The first embodiment described in the preceding paragraph can also include one or more of the additional aspects/features listed in the following bullet pointed paragraphs. Each of the below additional features of the first embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
Wherein the pyrolysis gas is provided by:
   (i) pyrolyzing a waste plastic to provide a pyrolysis effluent stream;
   (ii) cooling and at least partially condensing at least a portion of the pyrolysis effluent stream; and
   (iii) separating the cooled and at least partially condensed pyrolysis effluent stream to thereby provide at least a pygas stream and a pyrolysis oil (pyoil) stream.
      Wherein the pyrolysis effluent stream has a temperature of 500° C. to 800° C. after the pyrolyzing.
      Wherein the pyrolysis effluent stream is cooled to a temperature of 15° C. to 60° C., 25° C. to 45° C., or 30° C. to 40° C.
      Wherein the waste plastic comprises not more than 10, not more than 5, not more than 1, not more than 0.5, not more than 0.3, not more than 0.2, or not more than 0.1 percent by weight polyesters (e.g., PET).
      Wherein the waste plastic comprises at least 80, at least 90, at least 95, at least 99, or at least 99.9 percent by weight polyolefins.
      Wherein the pyrolysis effluent comprises:
         20 to 99 weight percent pyoil;
         1 to 90 weight percent pygas;
         to 25 weight percent pyrolysis residue; and/or
         not more than 15, 10, 5, 2, 1, 0.5 weight percent of free water.
      Wherein the pygas comprises:
         1 to 50 weight percent methane.
         5 to 99 weight percent C2, C3, and/or C4 hydrocarbon content
      Wherein the feedstock further comprises at least a portion of a cracker furnace effluent stream and/or at least a portion of the pyoil stream.
Wherein the pygas stream comprises one or more of:
   from 1-1000, 5-500, 10-200, 50-100 ppm hydrochloric acid (HCl);
   from 1-1000, 5-500, 10-300, 50-200 ppm halogens;
   from 1-1000, 5-500, 10-200, 50-100 ppm carbon dioxide (CO₂); and/or
   from 1-1000, 5-500, 10-200, 50-100 ppm hydrogen sulfide (H₂S).
Wherein the pygas stream is introduced into the caustic scrubber process at a pressure of 100 psia to 300 psia.
Wherein the caustic scrubber process removes carbon dioxide (CO₂) and/or sulfur (including sulfur-containing compounds) from the pygas stream, and thereby produces a treated gas stream and a spent caustic stream.
   Further comprising introducing at least a portion of the spent caustic stream into a waste water treatment facility.
   Further comprising using at least a portion of the spent caustic stream in a hydrochloric acid (HCl) neutralization process.
   further comprising:
      optionally, dehydrating and/or compressing at least a portion of the treated gas stream; and
      introducing the treated gas stream into a cryogenic separation process to produce recycled content chemical products and co-products comprising one or more olefins, alkanes, aromatics, hydrogen (H₂), paraffins, gasoline, and/or C5+ hydrocarbons.
Wherein the caustic scrubber process operates at a temperature of 25° C. to 65° C.
Wherein the caustic scrubber process comprises contacting the pygas with a caustic solution comprising a dissolved caustic component selected from the group consisting of sodium hydroxide, potassium hydroxide, calcium oxide, potassium carbonate, and combinations thereof.

### Additional Claim Supporting Description—Second Embodiment

In a second embodiment of the present technology, there is provided a process for purifying pyrolysis gas (pygas), the process comprising: (a) treating a pyrolysis gas (pygas) stream to provide a treated pygas stream depleted in halogens, carbon dioxide (CO₂), and/or sulfur; and (b) introducing at least a portion of the treated pygas stream into a caustic scrubber process.

The second embodiment described in the preceding paragraph can also include one or more of the additional aspects/features listed in the following bullet pointed paragraphs. Each of the below additional features of the second embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
Wherein the pyrolysis gas stream is produced by:
   (i) pyrolyzing a waste plastic to provide a pyrolysis effluent stream;
   (ii) cooling and at least partially condensing at least a portion of the pyrolysis effluent stream; and
   (iii) separating the cooled and at least partially condensed pyrolysis effluent stream to thereby provide at least the pygas stream and a pyrolysis oil (pyoil) stream.
      Wherein the pyrolysis effluent stream has a temperature of 500° C. to 800° C. after the pyrolyzing.
      Wherein the pyrolysis effluent stream is cooled to a temperature of 15° C. to 60° C., 25° C. to 45° C., or 30° C. to 40° C.
      Wherein the waste plastic comprises not more than 10, not more than 5, not more than 1, not more than 0.5, not more than 0.3, not more than 0.2, or not more than 0.1 percent by weight polyesters (e.g., PET).
      Wherein the waste plastic comprises at least 80, at least 90, at least 95, at least 99, or at least 99.9 percent by weight polyolefins.
      Wherein the pyrolysis effluent comprises:
         20 to 99 weight percent pyoil;
         1 to 90 weight percent pygas;
         0.1 to 25 weight percent pyrolysis residue; and/or
         not more than 15, 10, 5, 2, 1, 0.5 weight percent of free water.
      Wherein the pygas stream comprises:
         1 to 50 weight percent methane; and/or
         5 to 99 weight percent C2, C3, and/or C4 hydrocarbon content.
      Further comprising introducing at least a portion of the pyoil stream as a feedstock to a cracker furnace within the cracker facility.
         Wherein the feedstock to the caustic scrubber comprises at least a portion of a cracker furnace effluent stream from the cracker furnace.
Wherein the pygas stream comprises one or more of:
   from 1-1000, 5-500, 10-200, 50-100 ppm hydrochloric acid (HCl);
   from 1-1000, 5-500, 10-300, 50-200 ppm halogens;
   from 1-1000, 5-500, 10-200, 50-100 ppm carbon dioxide (CO₂); and/or
   from 1-1000, 5-500, 10-200, 50-100 ppm hydrogen sulfide (H₂S).
Wherein the pygas stream is introduced into the caustic scrubber process at a pressure of 100 psia to 300 psia.
Wherein the caustic scrubber process removes carbon dioxide (CO₂) and/or sulfur (including sulfur-containing compounds) from the pygas stream, and thereby produces a treated gas stream and a spent caustic stream.
   Further comprising introducing at least a portion of the spent caustic stream into a waste water treatment facility.
   Further comprising using at least a portion of the spent caustic stream in a hydrochloric acid (HCl) neutralization process.
   Further comprising:
      optionally, dehydrating and/or compressing at least a portion of the treated gas stream; and
      introducing the treated gas stream into a cryogenic separation process to produce recycled content chemical products and co-products comprising one or more olefins, alkanes, aromatics, hydrogen (H₂), paraffins, gasoline, and/or C5+ hydrocarbons.
Wherein the caustic scrubber process operates at a temperature of 25° C. to 65° C.
Wherein the caustic scrubber process comprises contacting the pygas with a caustic solution comprising a dissolved caustic component selected from the group consisting of sodium hydroxide, potassium hydroxide, calcium oxide, potassium carbonate, and combinations thereof.

### Additional Claim Supporting Description—Third Embodiment

In a third embodiment of the present technology, there is provided a process for purifying pyrolysis gas (pygas), the process comprising: (a) combining at least a portion of a cracker furnace effluent stream with a pyrolysis gas (pygas) stream to form a combined stream; and (b) feeding at least a portion of the combined stream into a caustic scrubber process.

The third embodiment described in the preceding paragraph can also include one or more of the additional aspects/features listed in the following bullet pointed paragraphs. Each of the below additional features of the third embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
Wherein the pyrolysis gas stream is produced by:
   (i) pyrolyzing a waste plastic to provide a pyrolysis effluent stream;
   (ii) cooling and at least partially condensing at least a portion of the pyrolysis effluent stream; and
   (iii) separating the cooled and at least partially condensed pyrolysis effluent stream to thereby provide at least the pygas stream and a pyrolysis oil (pyoil) stream.
      Wherein at least a portion of the cracker effluent stream is produced by steam cracking a feedstock comprising at least a portion of the pyoil stream.
      Wherein the pyrolysis effluent stream has a temperature of 500° C. to 800° C. after the pyrolyzing.
      Wherein the pyrolysis effluent stream is cooled to a temperature of 15° C. to 60° C., 25° C. to 45° C., or 30° C. to 40° C.
      Wherein the waste plastic comprises not more than 10, not more than 5, not more than 1, not more than 0.5, not more than 0.3, not more than 0.2, or not more than 0.1 percent by weight polyesters (e.g., PET).
      Wherein the waste plastic comprises at least 80, at least 90, at least 95, at least 99, or at least 99.9 percent by weight polyolefins.
      Wherein the pyrolysis effluent comprises:
         20 to 99 weight percent pyoil;
         1 to 90 weight percent pygas;
         0.1 to 25 weight percent pyrolysis residue; and/or
         not more than 15, 10, 5, 2, 1, 0.5 weight percent of free water.
      Wherein the pygas stream comprises:
         1 to 50 weight percent methane; and/or
         5 to 99 weight percent C2, C3, and/or C4 hydrocarbon content.
      Further comprising introducing at least a portion of the pyoil stream as a feedstock to a cracker furnace within the cracker facility.
         Wherein the feedstock to the caustic scrubber comprises at least a portion of a cracker furnace effluent stream from the cracker furnace.
Wherein the caustic scrubber comprises two or more (three or more, four or more, or five or more) stages.
Wherein the caustic scrubber process produces a treated effluent stream comprising not more than 1 ppm CO₂.
Wherein prior to the combining (a), at least a portion of the pygas stream is treated in an absorber-stripper system to thereby produce a CO₂-depleted pygas stream.
   Wherein the absorber-stripper system comprises one or more absorber towers and one or more regeneration towers.
      Wherein the treating (a) comprises introducing the pygas stream to the one or more absorber towers and contacting the pygas with an absorber solvent.
         Wherein the absorber solvent comprises a component selected from the group consisting of amines, methanol, sodium hydroxide, sodium carbonate/bicarbonate, potassium hydroxide, potassium carbonate/bicarbonate, SELEXOL®, glycol ether, and combinations thereof.
         Wherein the absorber solvent comprises a component selected from the group consisting of amines, methanol, SELEXOL®, glycol ether, and combinations thereof.
   Wherein treating the pygas stream in the absorber-stripper system removes sufficient CO₂ from the pygas stream such that the combined stream does not contain an average CO₂ content (e.g., as measured over a month period) greater than the CO₂ capacity of the caustic scrubber process.
   Wherein the combined stream comprises not more than 100 ppm CO₂ prior to feeding (b) to the caustic scrubber process.
   Wherein treating the pygas stream in the absorber-stripper system removes at least 70, at least 80, at least 90, at least 95, or at least 99 percent of the CO₂ from the pygas stream.
   Wherein treating the pygas stream in the absorber-stripper system removes at least 90, at least 95, at least 99, or at least 99.9% percent of the CO₂ and sulfur (including sulfur-containing compounds) from the pygas stream.
   Wherein treating the pygas stream in the absorber-stripper system removes sufficient CO₂ such that the combined stream comprises not more than 1000 ppm, not more than 500 ppm, not more than 400 ppm, not more than 300 ppm, not more than 200 ppm, or not more than 100 ppm CO₂.
Wherein the combined stream fed to the caustic scrubber process comprises not more than 100 ppm CO₂.
Wherein the pygas stream comprises one or more of:
   from 1-1000, 5-500, 10-200, 50-100 ppm hydrochloric acid (HCl);
   from 1-1000, 5-500, 10-300, 50-200 ppm halogens;
   from 1-1000, 5-500, 10-200, 50-100 ppm carbon dioxide (CO₂); and/or
   from 1-1000, 5-500, 10-200, 50-100 ppm hydrogen sulfide (H₂S).
Wherein the pygas stream is introduced into the caustic scrubber process at a pressure of 100 psia to 300 psia.
Wherein the caustic scrubber process removes carbon dioxide (CO₂) and/or sulfur (including sulfur-containing compounds) from the pygas stream, and thereby produces a treated gas stream and a spent caustic stream.
   Further comprising introducing at least a portion of the spent caustic stream into a waste water treatment facility.
   Further comprising using at least a portion of the spent caustic stream in a hydrochloric acid (HCl) neutralization process.
   Further comprising:
      optionally, dehydrating and/or compressing at least a portion of the treated gas stream; and
      introducing the treated gas stream into a cryogenic separation process to produce recycled content chemical products and co-products comprising one or more olefins, alkanes, aromatics, hydrogen (H₂), paraffins, gasoline, and/or C5+ hydrocarbons.
Wherein the caustic scrubber process operates at a temperature of 25° C. to 65° C.
Wherein the caustic scrubber process comprises contacting the pygas with a caustic solution comprising a dissolved caustic component selected from the group consisting of sodium hydroxide, potassium hydroxide, calcium oxide, potassium carbonate, and combinations thereof.

### Additional Claim Supporting Description—Fourth Embodiment

In a fourth embodiment of the present technology, there is provided a process for purifying pyrolysis gas (pygas), the process comprising: (a) treating a pyrolysis gas (pygas) stream in an absorber-stripper system to provide a treated pygas stream; and (b) introducing at least a portion of the treated pygas stream into a caustic scrubber process within a cracker facility.

The fourth embodiment described in the preceding paragraph can also include one or more of the additional aspects/features listed in the following bullet pointed paragraphs. Each of the below additional features of the third embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
Wherein the pyrolysis gas stream is produced by:
   (i) pyrolyzing a waste plastic to provide a pyrolysis effluent stream;
   (ii) cooling and at least partially condensing at least a portion of the pyrolysis effluent stream; and
   (iii) separating the cooled and at least partially condensed pyrolysis effluent stream to thereby provide at least the pygas stream and a pyrolysis oil (pyoil) stream.
      Wherein at least a portion of the cracker effluent stream is produced by steam cracking a feedstock comprising at least a portion of the pyoil stream.
      Wherein the pyrolysis effluent stream has a temperature of 500° C. to 800° C. after the pyrolyzing.
      Wherein the pyrolysis effluent stream is cooled to a temperature of 15° C. to 60° C., 25° C. to 45° C., or 30° C. to 40° C.
      Wherein the waste plastic comprises not more than 10, not more than 5, not more than 1, not more than 0.5, not more than 0.3, not more than 0.2, or not more than 0.1 percent by weight polyesters (e.g., PET).
      Wherein the waste plastic comprises at least 80, at least 90, at least 95, at least 99, or at least 99.9 percent by weight polyolefins.
      Wherein the pyrolysis effluent comprises:
         20 to 99 weight percent pyoil;
         1 to 90 weight percent pygas;
         0.1 to 25 weight percent pyrolysis residue; and/or
         not more than 15, 10, 5, 2, 1, 0.5 weight percent of free water.
      Wherein the pygas stream comprises:
         1 to 50 weight percent methane; and/or
         5 to 99 weight percent C2, C3, and/or C4 hydrocarbon content.
      Further comprising introducing at least a portion of the pyoil stream as a feedstock to a cracker furnace within the cracker facility.
         Wherein the feedstock to the caustic scrubber comprises at least a portion of a cracker furnace effluent stream from the cracker furnace.
Wherein the caustic scrubber comprises two or more (three or more, four or more, or five or more) stages.
Wherein the caustic scrubber process produces a treated effluent stream comprising not more than 1 ppm CO₂.
Wherein prior to the combining (a), at least a portion of the pygas stream is treated in an absorber-stripper system to thereby produce a CO₂-depleted pygas stream.
   Wherein the absorber-stripper system comprises one or more absorber towers and one or more regeneration towers.
      Wherein the treating (a) comprises introducing the pygas stream to the one or more absorber towers and contacting the pygas with an absorber solvent.
         Wherein the absorber solvent comprises a component selected from the group consisting of amines, methanol, sodium hydroxide, sodium carbonate/bicarbonate, potassium hydroxide, potassium carbonate/bicarbonate, SELEXOL®, glycol ether, and combinations thereof.
         Wherein the absorber solvent comprises a component selected from the group consisting of amines, methanol, SELEXOL®, glycol ether, and combinations thereof.
   Wherein treating the pygas stream in the absorber-stripper system removes sufficient CO₂ from the pygas stream such that the combined stream does not contain an average CO₂ content (e.g., as measured over a month period) greater than the CO₂ capacity of the caustic scrubber process.
   Wherein the combined stream comprises not more than 100 ppm CO₂ prior to feeding (b) to the caustic scrubber process.
   Wherein treating the pygas stream in the absorber-stripper system removes at least 70, at least 80, at least 90, at least 95, or at least 99 percent of the CO₂ from the pygas stream.
   Wherein treating the pygas stream in the absorber-stripper system removes at least 90, at least 95, at least 99, or at least 99.9% percent of the CO₂ and sulfur (including sulfur-containing compounds) from the pygas stream.
   Wherein treating the pygas stream in the absorber-stripper system removes sufficient CO₂ such that the combined stream comprises not more than 1000 ppm, not more than 500 ppm, not more than 400 ppm, not more than 300 ppm, not more than 200 ppm, or not more than 100 ppm CO₂.
Wherein the combined stream fed to the caustic scrubber process comprises not more than 100 ppm CO₂.
Wherein the pygas stream comprises one or more of:
   from 1-1000, 5-500, 10-200, 50-100 ppm hydrochloric acid (HCl);
   from 1-1000, 5-500, 10-300, 50-200 ppm halogens;
   from 1-1000, 5-500, 10-200, 50-100 ppm carbon dioxide (CO₂); and/or
   from 1-1000, 5-500, 10-200, 50-100 ppm hydrogen sulfide (H₂S).
Wherein the pygas stream is introduced into the caustic scrubber process at a pressure of 100 psia to 300 psia.
Wherein the caustic scrubber process removes carbon dioxide (CO₂) and/or sulfur (including sulfur-containing compounds) from the pygas stream, and thereby produces a treated gas stream and a spent caustic stream.
   Further comprising introducing at least a portion of the spent caustic stream into a waste water treatment facility.
   Further comprising using at least a portion of the spent caustic stream in a hydrochloric acid (HCl) neutralization process.
   Further comprising:
      optionally, dehydrating and/or compressing at least a portion of the treated gas stream; and
      introducing the treated gas stream into a cryogenic separation process to produce recycled content chemical products and co-products comprising one or more olefins, alkanes, aromatics, hydrogen (H₂), paraffins, gasoline, and/or C5+ hydrocarbons.
Wherein the caustic scrubber process operates at a temperature of 25° C. to 65° C.
Wherein the caustic scrubber process comprises contacting the pygas with a caustic solution comprising a dissolved caustic component selected from the group consisting of sodium hydroxide, potassium hydroxide, calcium oxide, potassium carbonate, and combinations thereof.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process for purifying pyrolysis gas (pygas), the process comprising:
(a) providing a pygas by:
(i) pyrolyzing a waste plastic to provide a pyrolysis effluent stream;
(ii) cooling and at least partially condensing at least a portion of the pyrolysis effluent stream; and
(iii) separating the cooled and at least partially condensed pyrolysis effluent stream to thereby provide at least a pygas stream and a pyrolysis oil (pyoil) stream,
wherein the pygas stream comprises one or more of:
(i) greater than 1 ppm of hydrochloric acid (HCl);
(ii) greater than 1 ppm of carbon dioxide (CO₂); and/or
(iii) greater than 1 ppm of hydrogen sulfide (H₂S); and
(b) feeding a gas stream comprising at least a portion of the pygas and a pyoil stream comprising at least a portion of the pyoil to a cracker facility that comprises a cracker furnace and a caustic scrubber process downstream of the cracker furnace,
(c) introducing the gas stream into the caustic scrubber process, and
(d) introducing at least a portion of the pyoil stream as a feedstock to the cracker furnace.

2. (canceled)

3. (canceled)

4. The process of claim 1, further comprising:
(a) treating a pyrolysis gas (pygas) stream to provide a treated pygas stream depleted in halogens, carbon dioxide (CO₂), and/or sulfur; and
(b) introducing at least a portion of the treated pygas stream into a caustic scrubber process.

5. The process of claim 4, wherein the treating (a) comprises:
(i) removing carbon dioxide (CO₂) from the pygas stream in an absorber-stripper system;
(ii) removing sulfur and/or sulfur-containing compounds from the pygas stream by contacting the pygas stream with at least one reactant material; and/or
(iii) removing halogens from the pygas stream by contacting the pygas stream with a halogen-removal material.

6. The process of claim 4, wherein the caustic scrubber process removes carbon dioxide (CO₂) and/or sulfur from the treated pygas stream, and thereby produces a treated gas stream and a spent caustic stream.

7. The process of claim 6, further comprising using at least a portion of the spent caustic stream in a hydrochloric acid (HCl) neutralization process.

8. The process of claim 4, further comprising:
(i) optionally, dehydrating and/or compressing at least a portion of the treated gas stream; an
(ii) introducing the treated gas stream into a cryogenic separation process to produce recycled content chemical products and co-products comprising one or more olefins, alkanes, aromatics, hydrogen (H₂), paraffins, gasoline, and/or C5+ hydrocarbons.

9. The process of claim 1, further comprising:
(a) combining at least a portion of a cracker furnace effluent stream with a pyrolysis gas (pygas) stream to form a combined stream; and
(b) feeding at least a portion of the combined stream into a caustic scrubber process.

10. (canceled)

11. The process of claim 9, wherein at least a portion of the cracker effluent stream is produced by steam cracking a feedstock comprising at least a portion of the pyoil stream.

12. The process of claim 9, wherein the caustic scrubber process produces a treated effluent stream comprising not more than 1 ppm CO2.

13. The process of claim 9, wherein prior to the combining (a), at least a portion of the pygas stream is treated in an absorber-stripper system to thereby produce a CO₂-depleted pygas stream.

14. The process of claim 13, wherein treating the pygas stream in the absorber-stripper system removes sufficient CO₂ from the pygas stream such that the combined stream does not contain an average CO₂ content greater than the CO₂ capacity of the caustic scrubber process.

15. The process of claim 13, wherein the combined stream comprises not more than 100 ppm CO2 prior to feeding (b) to the caustic scrubber process.

16. The process of claim 13, wherein treating the pygas stream in the absorber-stripper system removes at least 90 percent of the CO2 from the pygas stream.

17. The process of claim 1, further comprising:
(a) treating a pyrolysis gas (pygas) stream in an absorber-stripper system to provide a treated pygas stream; and
(b) introducing at least a portion of the treated pygas stream into the caustic scrubber process,
wherein the absorber-stripper system comprises one or more absorber towers and one or more regeneration towers, and
wherein the treating (a) comprises introducing the pygas stream to the one or more absorber towers and contacting the pygas with an absorber solvent within a cracker facility.

18. (canceled)

19. (canceled)

20. The process of claim 17, wherein the absorber solvent comprises a component selected from the group consisting of amines, methanol, sodium hydroxide, sodium carbonate/bicarbonate, potassium hydroxide, potassium carbonate/bicarbonate, SELEXOL®, glycol ether, and combinations thereof.
